(19) United States
(12) Patent Application Publication
(10) Pub. No.: US 2026/0186858 A1
(43) Pub. Date: Jul. 2, 2026

(54) LOW MEMORY SPARSE BIT-ARRAY

(71) Applicant: Dell Products L.P., Round Rock, TX (US)

(72) Inventors: Dvir Koren, Nahalal (IL); Tal Abir, Nesher (IL)

(21) Appl. No.: 19/001,877

(22) Filed: Dec. 26, 2024

(51) Int. Cl. G06F 9/50

(52) U.S. Cl. CPC G06F 9/5077; G06F 9/5016

(57) ABSTRACT

The disclosure includes a virtual sparse bit-array (VSB) having a low memory structure. The low memory structure is designed to increase processing speed for operations executed on the VSB. The VSB may be in a pointer tree structure or an offset tree structure. The VSB includes blocks, levels, and special pointers. The blocks are distributed on the levels to form the tree structure. The special pointers include a real pointer that connects the blocks across levels of the VSB tree structure, zero pointers which indicate all bits in the block and blocks connected to the block from levels below are reset to zero, and max pointers (FF), which indicate all bits in the block and blocks connected to the block from levels below are set to one. Methods herein describe how to allocate and deallocate sets of blocks at each level to achieve maximum memory efficiency.

### BACKGROUND

Bit-arrays are array data structures that compactly store bits in computing systems. A bit-array includes a set of bits either set to one or reset to zero. The bits in a bit-array can be changed using bitwise operations. Bit-arrays are compact and are used in areas where space or efficiency is required. Bit-arrays are implemented as big sequential memory chunks. When a usage of a given bit-array is sparse (i.e., only a few bits in the bit-array are set to one), memory footprint (i.e., the amount of memory the bit-array uses to describe the bits) of the bit-array may be high relative to the amount of bits set (e.g., if 20 bits of data are set in a bit-array that includes one million bits, the memory footprint is one million bits compared to the 20 bits set) and bitwise operations may execute slowly with respect to the amount of bits set.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a diagram of a system in accordance with one or more embodiments disclosed herein.

FIG. 2 shows a diagram of an information handling system (IHS) in accordance with one or more embodiments disclosed herein.

FIGS. 3.1-3.3 show visual representations of example virtual sparse bit-arrays (VSBs) in accordance with one or more embodiments disclosed herein.

FIG. 4 shows a memory translation table for converting a VSB from a pointer tree to an offset tree in accordance with one or more embodiments disclosed herein.

FIG. 5 shows a flow diagram describing a method of adjusting bits in a VSB in accordance with one or more embodiments disclosed herein.

FIG. 6 shows a flow diagram describing a method of adjusting bits in a VSB in accordance with one or more embodiments disclosed herein.

FIGS. 7.1-7.3 show an example use case indicating how to adjust bits in a VSB in accordance with one or more embodiments disclosed herein.

FIG. 8 shows an example table of the storage capacity of a VSB in accordance with one or more embodiments disclosed herein.

FIG. 9 shows a diagram of a computing device in accordance with one or more embodiments disclosed herein.

### DETAILED DESCRIPTION

In general, bit-arrays are implemented as one bit-array of bits (i.e., a big sequential memory chunk). If a usage of a corresponding bit-array is sparse (i.e., only a few bits in the bit-array are set to one), memory of a computing device storing the bit-array is inefficiently used due to the high amount of memory needed to describe the entire bit-array. Said another way, memory footprint (i.e., the amount of memory the bit-array uses to describe the bits contained in the bit-array) of the bit-array relative to the amount of bits set is high. The high memory footprint may lead to inefficient transmission of the bit-array over a network and inefficient use of memory if the bit-array is written to persistent memory. Operations performed on the bit-array may execute slowly relative to the number of bits set. For example, an OR operation and/or an AND operation between two bit-arrays may be executed slowly if a usage of at least one of the two bit-arrays is sparse. As yet another example, a set/reset all operation that causes all bits in a bit array to be either set to one or reset to zero (e.g., for cleanup or for initialization of the bit-array) may execute slowly if a usage of the bit-array is sparse. As yet another example, the high memory footprint of traditional bit-arrays (when sparse) is an inefficient use of memory of the system (containing the bit-array) when performing an operation on the bit-array or storing the bit-array in the memory.

For at least the reasons discussed above, a fundamentally different approach/framework is needed to improve operation speed and resolve inefficient use of memory in computing devices including sparse usage bit-arrays.

Embodiments disclosed herein relate to a VSB including a low memory structure that is more memory efficient. The low memory structure is designed to increase processing speed of operations executed on the VSB (e.g., AND operations, OR operations, etc.). Further, the VSB is random access memory (RAM) efficient, and the low memory structure has a small data structure leading to a reduction of disk usage compared to a standard/traditional bit-array (when the VSB is copied to the disk). The low memory structure leads to improvements in sending the VSB over a network compared to a standard bit-array because of the reduction in memory usage. Procedures for setting and resetting bits in the VSB ((i) to allocate block sets on different levels of the VSB and (ii) to deallocate block sets on different levels of the VSB) are discussed below. As a result of the procedures/processes discussed below, one or more embodiments disclosed herein advantageously ensure a reduction in memory usage for the VSB compared to traditional sparse bit-arrays.

The following describes various embodiments disclosed herein.

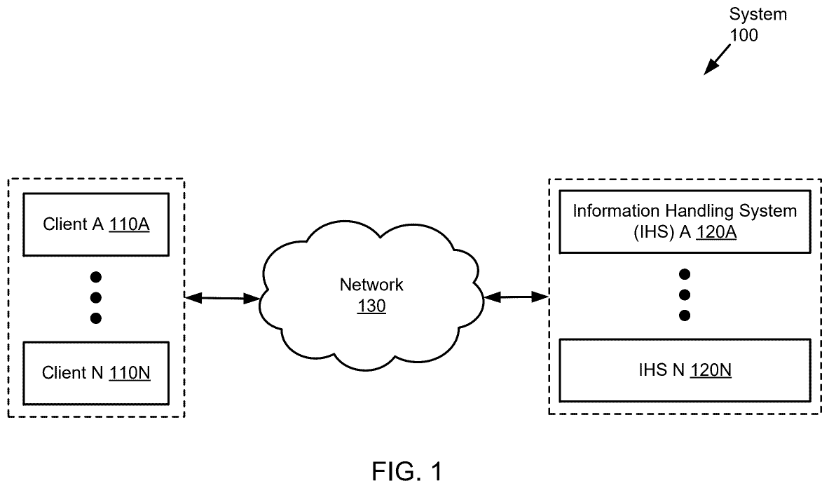

FIG. 1 shows a diagram of a system (100) in accordance with one or more embodiments disclosed herein. The system (100) may be used in the creation, modification, and use of VSBs. The system (100) is not meant to be limiting to the VSBs as other systems may be used to create, modify, and use the VSBs. The system (100) includes any number of clients (e.g., Client A (110A), Client N (110N), etc.), a network (130), any number of IHSs (e.g., IHS A (120A), IHS N (120N), etc.)). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110N, etc.), the IHSs (e.g., 120A, 120N, etc.), and the network (130) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110N, etc.) and the IHSs (e.g., 120A, 120N, etc.) are shown to be operatively connected through a communication network (e.g., 130), the clients (e.g., 110A, 110N, etc.) and the IHSs (e.g., 120A, 120N, etc.) may be directly connected (e.g., without an intervening communication network).

Further, the functioning of the clients (e.g., 110A, 110N, etc.) and the IHSs (e.g., 120A, 120N, etc.) is not dependent upon the functioning and/or existence of the other components (e.g., devices) in the system (100). Rather, the clients (e.g., 110A, 110N, etc.) and the IHSs (e.g., 120A, 120N, etc.) may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

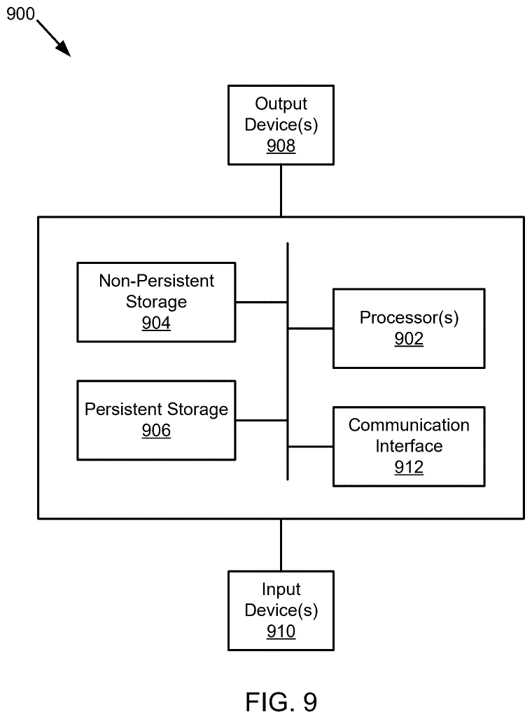

In one or more embodiments, the system (100) may be a distributed system (e.g., a data processing environment) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., 110A, 110N, etc.). The system (100) may also represent a comprehensive middleware layer executing on computing devices (e.g., 900, FIG. 9) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to users, the system (100) may perform some computations (e.g., data collection, distributed processing of collected data, etc.) locally (e.g., at the users' site using the clients (e.g., 110A, 110N, etc.)) and other computations remotely (e.g., away from the users' site using the IHSs (e.g., 120A, 120N, etc.)) from the users. By doing so, the users may utilize different computing devices (e.g., 900, FIG. 9) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IHSs (e.g., 120A, 120N, etc.)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to an IHS (e.g., 120A). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or computing device operated by one or more individuals of (or employed by) an organization. Examples of said individual(s) may include, but not limited to, any organization executive(s) (e.g., chief executive officer (CEO), chief financial officer (CFO), etc.) and any employee(s) in the data management team of the organization (e.g., an administrator). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with an IHS (e.g., 120A). For example, the clients may issue requests to the IHS to receive responses and interact with various components of the IHS. The clients may also request data from and/or send data to the IHS (for example, the clients may transmit information to the IHS that allows the IHS to perform computations, the results of which are used by the clients to provide services to the users). As yet another example, the clients may utilize computer-implemented services provided by the IHS. When the clients interact with the IHS, data that is relevant to the clients may be stored (temporarily or permanently) in the IHS.

In one or more embodiments, a client (e.g., 110A, 110N, etc.) may be capable of, e.g.: (i) collecting users' inputs, (ii) correlating collected users' inputs to the computer-implemented services to be provided to the users, (iii) communicating with an IHS (e.g., 120A) that perform computations necessary to provide the computer-implemented services, (iv) using the computations performed by the IHS to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IHS (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high-speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), RAM, Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface controller (NIC)/network adapter, a network processor, etc.

In one or more embodiments, a networking resource may provide capabilities to interface a client with external entities (e.g., 120A, 120N, etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8 GB of PMEM and 1 CPU with 16 cores. Other different computational capabilities of the clients not listed above may also be taken into account without departing from the scope of the embodiments disclosed herein.

Further, in one or more embodiments, a client (e.g., 110A, 110N, etc.) may be implemented as a computing device (e.g., 900, FIG. 9). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., customers, administrators, organization executives, people, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing the virtualization technology. In one or more embodiments, an administrator may be a user/person/human with permission (e.g., a user that has root-level access) to make changes on the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 900, FIG. 9) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

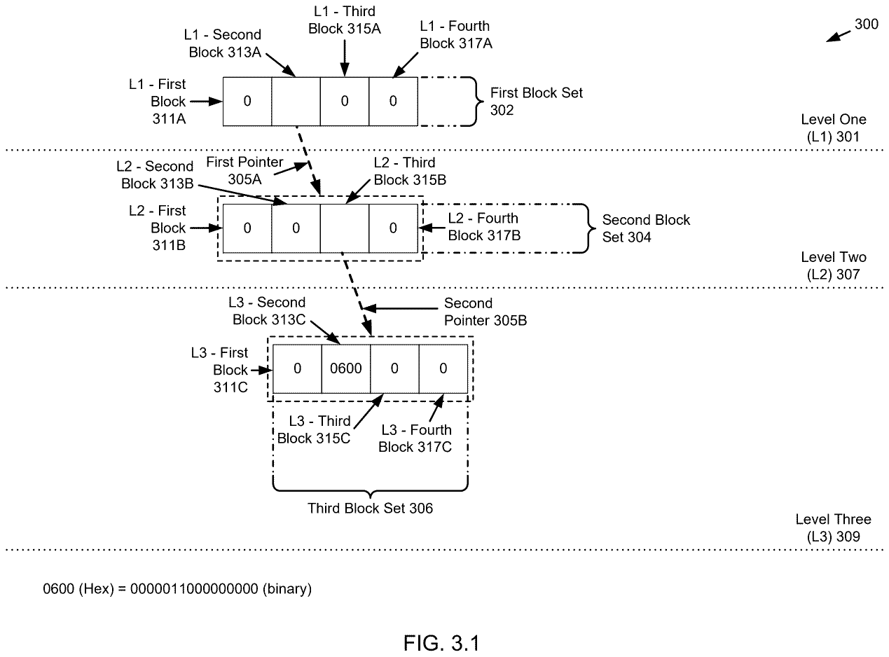

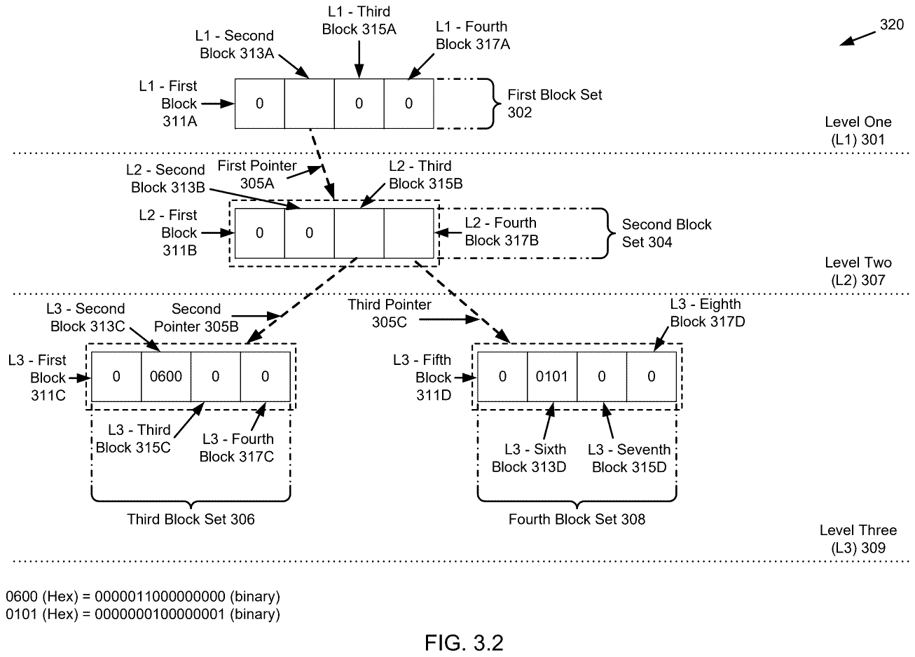

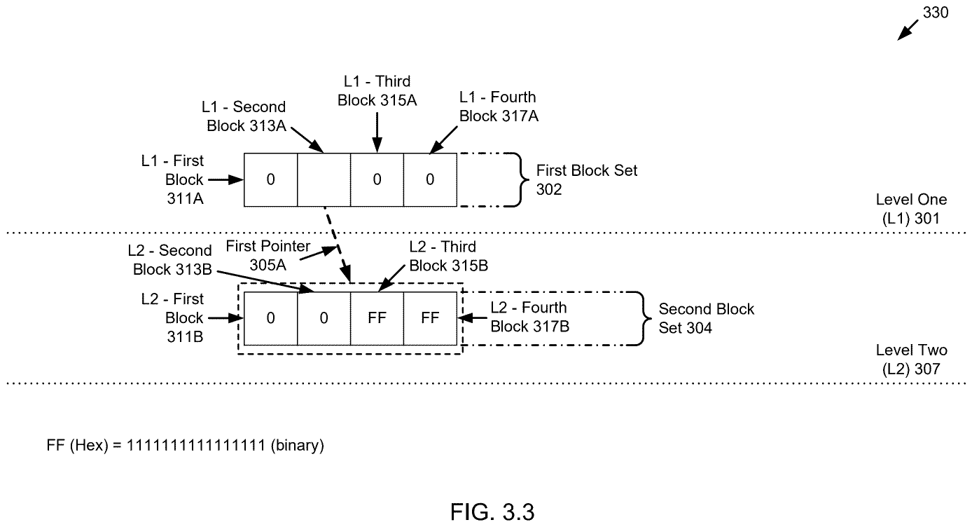

In one or more embodiments, one or more VSBs (see e.g., FIGS. 3.1-3.3) may be used by the clients (e.g., 110A, 110N, etc.) to store any sensor data gathered by the clients and used with any of the applications described. The clients (e.g., 110A, 110N, etc.), using one or more VSBs to store information, may perform other types of functionalities not listed above without departing from the scope of the embodiments disclosed herein. A VSB may be created and/or modified on a client (e.g., 110A, 110N, etc.) by one or more processors hosted in the client. Further, a VSB may be stored in the storage or memory resource (not shown) of a client (e.g., 110A, 110N, etc.) described above.

In one or more embodiments, the group of IHSs (e.g., 120A, 120N, etc.) may represent, for example, a network environment (e.g., a public network environment, a private network environment, etc.). Further, the group of IHSs (e.g., 120A, 120N, etc.) may correspond to a geographic region in the world and/or a zone (e.g., a business operation zone) of an organization.

In one or more embodiments, an IHS (e.g., 120A) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, an IHS (e.g., 120A) may include functionality to, e.g.: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to a database (not shown) for management of the data and/or for storage of the data (while pushing the data, the IHS may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or machine learning (ML) models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IHS (e.g., 120N) for review and/or other human interactions; (x) exchange data with other devices registered in/to the network (130) in order to, for example, participate in a collaborative workload placement (e.g., the IHS may split up a request (e.g., an operation, a task, an activity, etc.) with another IHS, coordinating its efforts to complete the request more efficiently than if the IHS had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the database; (xv) provide (e.g., via a broadcast, multicast, or unicast mechanism) information (e.g., a location identifier, the amount of available resources, etc.) associated with the IHS to other IHSs of the system (100); (xvi) configure or control any mechanism that defines when, how, and what data to provide to the clients and/or database; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., the IHS may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IHS may communicate with, for example, the database and/or other storage devices in the system (100).

As described above, an IHS (e.g., 120A) may be capable of providing a range of functionalities/services to the users of the clients (e.g., 110A, 110N, etc.). However, not all of the users may be allowed to receive all of the services. To manage the services provided to the users of the clients, a system (e.g., a service manager) in accordance with embodiments disclosed herein may manage the operation of a network (e.g., 130), in which the clients are operably connected to the IHS. Specifically, the service manager (i) may identify services to be provided by the IHS (for example, based on the number of users using the clients) and (ii) may limit communications of the clients to receive IHS provided services.

For example, the priority (e.g., the user access level) of a user may be used to determine how to manage computing resources of the IHS to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IHS (e.g., while the computing resources of the IHS may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high-priority user (e.g., a privileged user, a user with a user access level of 9/10). In such a case, the user level of that user may indicate that more ports are to be opened than were for the first user so that (i) the IHS may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

Further, while a single IHS (e.g., 120A) is considered above, the term “IHS” includes any collection of systems or sub-systems that individually or jointly execute a set, or multiple sets, of instructions to provide one or more computer-implemented services. For example, a single IHS may provide a computer-implemented service on its own (i.e., independently) while multiple other IHSs may provide a second computer-implemented service cooperatively (e.g., each of the multiple other IHSs may provide similar and or different services that form the cooperatively provided service).

As described above, an IHS (e.g., 120A) may provide any quantity and any type of computer-implemented services. To provide computer-implemented services, the IHS may be a heterogeneous set, including a collection of physical computing components/resources configured to perform operations of the IHS and/or otherwise execute a collection of logical computing components/resources of the IHS.

In one or more embodiments, a “computing” resource (e.g., a measurable quantity of a compute-relevant resource type that may be requested, allocated, and/or consumed) may be (or may include), for example (but not limited to): a CPU, a GPU, a DPU, memory, a network resource, storage space (e.g., to store any type and quantity of information), storage input/output, a hardware resource set, a compute resource set (e.g., one or more processors, processor dedicated memory, etc.), a control resource set, etc.

In one or more embodiments, resources (or computing resources) of an IHS (e.g., 120A) may be divided into three logical resource sets: a compute resource set, a control resource set, and a hardware resource set. Different resource sets, or portions thereof, from the same or different IHSs may be aggregated (e.g., caused to operate as a computing device) to instantiate a composed IHS having at least one resource set from each set of the three resource set model.

In one or more embodiments, a hardware resource set (e.g., of an IHS) may include (or specify), for example (but not limited to): a configurable CPU option (e.g., a valid/legitimate vCPU count per-IHS option), a minimum user count per-IHS, a maximum user count per-IHS, a configurable network resource option (e.g., enabling/disabling single-root input/output virtualization (SR-IOV) for specific IHSs), a configurable memory option (e.g., maximum and minimum memory per-IHS), a configurable GPU option (e.g., allowable scheduling policy and/or vGPU count combinations per-IHS), a configurable DPU option (e.g., legitimacy of disabling inter-integrated circuit (I2C) for various IHSs), a configurable storage space option (e.g., a list of disk cloning technologies across all IHSs), a configurable storage input/output option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template, a 10 GB/s BW with 10 ms latency QoS template, etc.), a DPU related template (e.g., a 1 GB/s BW vDPU with 1 GB vDPU frame buffer template, a 2 GB/s BW vDPU with 1 GB vDPU frame buffer template, etc.), a GPU related template (e.g., a depth-first vGPU with 1 GB vGPU frame buffer template, a depth-first vGPU with 2 GB vGPU frame buffer template, etc.), a storage space related template (e.g., a 40 GB SSD storage template, an 80 GB SSD storage template, etc.), a CPU related template (e.g., a 1 vCPU with 4 cores template, a 2 vCPUs with 4 cores template, etc.), a memory related template (e.g., a 4 GB DRAM template, an 8 GB DRAM template, etc.), a speed select technology configuration (e.g., enabled, disabled, etc.), a virtual NIC (vNIC) count per-IHS, a wake on LAN support configuration (e.g., supported/enabled, not supported/disabled, etc.), a swap space configuration per-IHS, a reserved memory configuration (e.g., as a percentage of configured memory such as 0-100%), a memory ballooning configuration (e.g., enabled, disabled, etc.), a vGPU count per-IHS, a type of a vGPU scheduling policy (e.g., a “fixed share” vGPU scheduling policy, an “equal share” vGPU scheduling policy, etc.), a type of a GPU virtualization approach (e.g., graphics vendor native drivers approach such as a vGPU), a storage mode configuration (e.g., an enabled high-performance storage array mode, a disabled high-performance storage array mode, an enabled general storage (i.e., co-processor) mode, a disabled general storage mode, etc.), a backup frequency (e.g., hourly, daily, monthly, etc.), a hardware virtualization configuration, etc.

In one or more embodiments, a control resource set (e.g., of an IHS) may facilitate formation of composed IHSs. To do so, a control resource set may prepare any quantity of computing resources from any number of hardware resource sets (e.g., of the corresponding IHS and/or other IHSs) for presentation. Once prepared, the control resource set may present the prepared computing resources as bare metal resources to an orchestrator (not shown). By doing so, a composed IHS may be instantiated.

To prepare the computing resources of the hardware resource sets for presentation, the control resource set may employ, for example, virtualization, indirection, abstraction, and/or emulation. These management functionalities may be transparent to applications hosted by the resulting composed IHS (e.g., thereby relieving those applications from workload overhead). Consequently, while unknown to components of a composed IHS, the composed IHS may operate in accordance with any number of management models thereby providing for unified control and management of the composed IHS.

In one or more embodiments, the orchestrator may implement a management model to manage computing resources (e.g., computing resources provided by one or more hardware components/devices of IHSs) in a particular manner. The management model may give rise to additional functionalities for the computing resources. For example, the management model may be automatically storing multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and numbers of management models may be implemented to provide additional functionalities using the computing resources without departing from the scope of the embodiments disclosed herein.

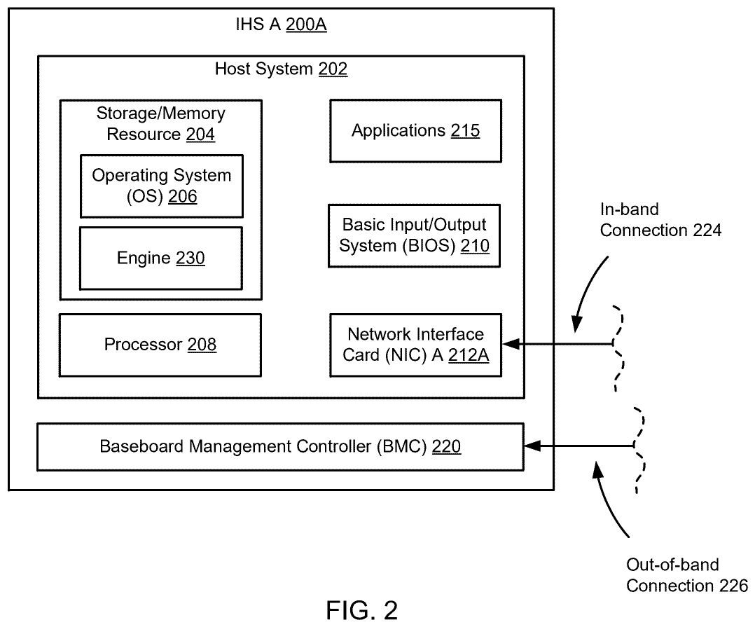

In one or more embodiments, in conjunction with the orchestrator, a system control processor (not shown) of a related IHS may cooperatively enable hardware resource sets of other IHSs to be prepared and presented as bare metal resources to composed IHSs. The system control processor may be operably connected to external resources (not shown) via a NIC (e.g., 212A, FIG. 2) and the network (130) so that the system control processor may prepare and present the external resources as bare metal resources as well.

In one or more embodiments, a compute resource set, a control resource set, and/or a hardware resource set may be implemented as separate physical devices. In such a scenario, any of these resource sets may include NICs or other devices to enable the hardware devices of the respective resource sets to communicate with each other.

While an IHS (e.g., 120A) has been illustrated and described as including a limited number of specific components and/or hardware resources, the IHS (e.g., 120A) may include additional, fewer, and/or different components without departing from the scope of the embodiments disclosed herein. One of ordinary skill will appreciate that an IHS (e.g., 120A) may perform other functionalities without departing from the scope of the embodiments disclosed herein.

In one or more embodiments, an IHS (e.g., 120A) may be implemented as a computing device (e.g., 900, FIG. 9). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored to the persistent storage, that when executed by the processor(s) of the computing device cause the computing device to perform the functionality of the IHS described throughout the application.

Alternatively, in one or more embodiments, similar to a client (e.g., 110A), the IHS (e.g., 120A) may also be implemented as a logical device.

In one or more embodiments, one or more VSBs may be used by an IHS (e.g., 120A) to store compact data structures such as flags, configuration settings, or status indicators for the IHS (e.g., 120A). VSBs may also be used in conjunction with computer-implemented services provided by the IHS (e.g., 120A). VSBs may be used in conjunction with other tasks, performed by the IHS (e.g., 120A), not listed above without departing from the scope of the embodiments disclosed herein. The VSBs may be created and modified on the IHS (e.g., 120A) as described in FIG. 2.

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IHSs, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IHSs through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

In one or more embodiments, a VSB may be transmitted over the network (130) from a client (e.g., 110A) to an IHS (e.g., 120A) and vice versa.

While FIG. 1 shows a configuration of components, other system configurations may be used without departing from the scope of the embodiments disclosed herein.

Turning now to FIG. 2, FIG. 2 shows a diagram of an IHS (e.g., IHS A) in accordance with one or more embodiments disclosed herein. IHS A (200A) may be an example of an IHS discussed above in reference to FIG. 1. IHS A (200A) may include (i) a host system (202) that hosts a storage/memory resource (204), a processor (208), a BIOS (210) (e.g., a unified extensible firmware interface (UEFI) BIOS), any number of applications (215), and a NIC (e.g., NIC A 212A) and (ii) a baseboard management controller (BMC) (220) that hosts a processor (not shown) and a NIC (not shown). IHS A (200A) may include additional, fewer, and/or different components without departing from the scope of the embodiments disclosed herein. Each component may be operably connected to any of the other component via any combination of wired and/or wireless connections. Each component illustrated in FIG. 2 is discussed below.

In one or more embodiments, the processor (208) (e.g., a node processor, one or more processor cores, one or more processor micro-cores, etc.) may be communicatively coupled to the storage/memory resource (204), the BIOS (210), the applications (215), and NIC A (212A) via any suitable interface, for example, a system interconnect including one or more system buses (operable to transmit communication between various hardware components) and/or peripheral component interconnect express (PCIe) bus/interface. In one or more embodiments, the processor (208) may be configured for executing machine-executable code like a CPU, a programmable logic array (PLA), an embedded device such as a System-on-a-Chip (SoC), or hardware/software control logic.

More specifically, the processor (208) may include any system, device, or apparatus configured to interpret and/or execute program instructions and/or process data, and may include, without limitation, a memory controller, microprocessor, a microcontroller, a digital signal processor (DSP), an ASIC, or any other digital or analog circuitry configured to interpret and/or execute program instructions and/or process data. In one or more embodiments, the processor (208) may interpret and/or execute program instructions and/or process data stored to the storage/memory resource (204) and/or another component of IHS A (200A).

In one or more embodiments, the processor (208) may utilize NIC A (212A) to communicate with other devices to manage (e.g., instantiate, monitor, modify, etc.) composed IHSs. Additionally, the processor (208) may manage operation of hardware devices of IHS A (200A) in accordance with one or more models including, for example, data protection models, security models such as encrypting stored data, workload performance availability models such as implementing statistic characterization of workload performance, reporting models, etc. For example, the processor (208) may instantiate redundant performance of workloads for high-availability services.

In one or more embodiments, the processor (208) may facilitate instantiation of composed IHSs. By doing so, a system that includes IHSs may dynamically instantiate composed IHSs to provide computer-implemented services.

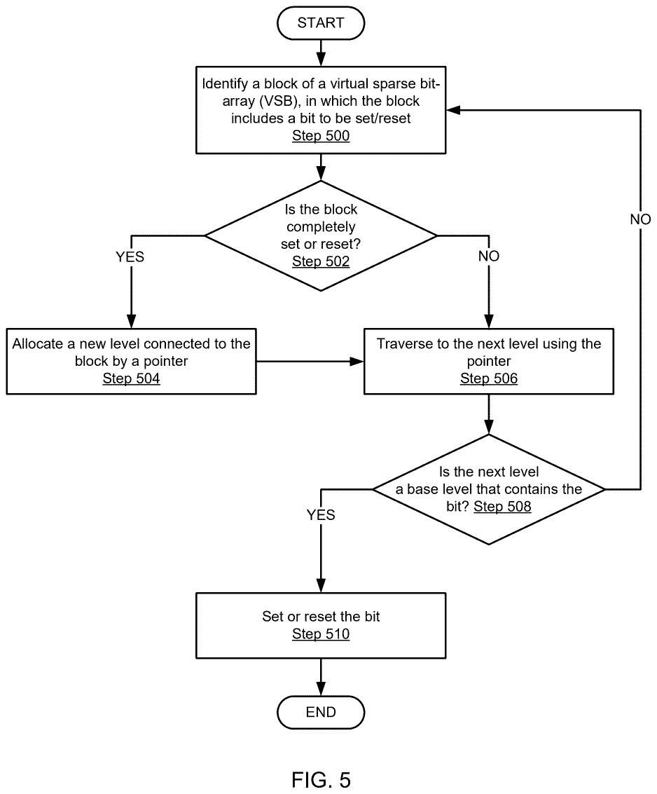

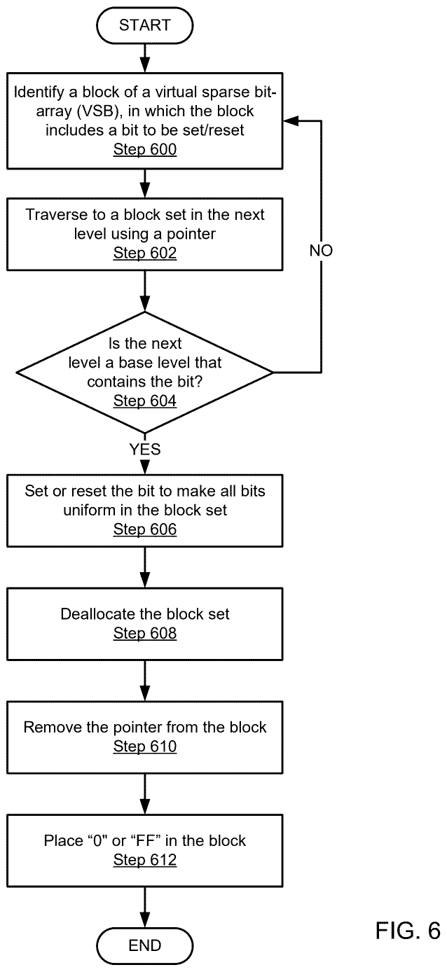

In one or more embodiments, the processor (208) is used to create, store, receive, modify, and/or use VSBs on IHS A (200A). The processor (208) may be used in conjunction with other components (e.g., an engine (230)) to perform (i) methods described below in reference to FIGS. 5 and 6, and (ii) processes described below in reference to FIGS. 3.1-3.3, 4, and 8.

While the processor (208) has been illustrated and described as including a limited number of specific components, the processor (208) may include additional, fewer, and/or different components without departing from the scope of the embodiments disclosed herein. One of ordinary skill will appreciate that the processor (208) may perform other functionalities without departing from the scope of the embodiments disclosed herein. The processor (208) may be implemented using hardware (e.g., a physical device including circuitry), software, or any combination thereof.

In one or more embodiments, when two or more components are referred to as “coupled” to one another, such term indicates that such two or more components are in electronic communication or mechanical communication, as applicable, whether connected directly or indirectly, with or without intervening components.

In one or more embodiments, the storage/memory resource (204) may have or provide at least the functionalities and/or characteristics of the storage or memory resources described above in reference to FIG. 1. The storage/memory resource (204) may include any instrumentality or aggregation of instrumentalities that may retain data (e.g., OS data, tamper-protected data, application data, etc.), program instructions, applications, and/or firmware (temporarily or permanently). In one or more embodiments, software and/or firmware stored within the storage/memory resource (204) may be loaded into the processor (208) and executed during operation of IHS A (200A). The storage/memory resource (204) includes the OS (206) and the engine (230).

Further, the storage/memory resource (204) may include, without limitation, (i) storage media such as a direct access storage device (e.g., an HDD or a floppy disk), a sequential access storage device (e.g., a tape disk drive), compact disk, CD-ROM, DVD, RAM, DRAM, read-only memory (ROM), electrically erasable programmable read-only memory (EEPROM), magnetic storage, opto-magnetic storage, and/or volatile or non-volatile memory (e.g., Flash memory) that retains data after power to IHS A (200A) is turned off; (ii) communications media such as wires, optical fibers, microwaves, radio waves, and other electromagnetic and/or optical carriers; and/or any combination of thereof.

Although the storage/memory resource (204) is depicted as integral to the host system (202), in some embodiments, all or a portion of the storage/memory resource (204) may reside external to the host system (202).

In one or more embodiments, the OS (206) may include any program of executable instructions (or aggregation of programs of executable instructions) configured to manage and/or control the allocation and usage of hardware resources such as memory, processor time, disk space, and input/output devices, and provide an interface between such hardware resources and applications hosted by the OS (206). Further, the OS (206) may include all or a portion of a network stack for network communication via a network interface (e.g., NIC A (212A) for communication over a data network (e.g., an in-band connection (224))).

In one or more embodiments, active portions of the OS (206) may be transferred to the storage/memory resource (204) for execution by the processor (208). Although the OS (206) is shown in FIG. 2 as stored to the storage/memory resource (204), in some embodiments, the OS (206) may be stored to external storage media accessible to the processor (208), and active portions of the OS (206) may be transferred from such external storage media to the storage/memory resource (204) for execution by the processor (208).

The engine (230) is configured to create, modify, and/or store VSBs in IHS A (200A). The engine (230) may perform the methods described below in reference to FIGS. 5-6 in conjunction with the processor (208).

In one or more embodiments, the firmware stored to the storage/memory resource (204) may include power profile data and thermal profile data for certain hardware devices (e.g., the processor (208), the BIOS (210), NIC A (212A), input/output controllers, etc.). Further, the storage/memory resource (204) may include a UEFI interface (not shown) for accessing the BIOS (210) as well as updating the BIOS (210). In most cases, the UEFI interface may provide a software interface between the OS (206) and the BIOS (210) and may support remote diagnostics and repair of hardware devices, even with no OS is installed.

In one or more embodiments, the input/output controllers (not shown) may manage the operation(s) of one or more input/output device(s) (connected/coupled to IHS A (200A)), for example (but not limited to): a keyboard, a mouse, a touch screen, a microphone, a monitor or a display device, a camera, an optical reader, a USB, a card reader, a personal computer memory card international association (PCMCIA) slot, a high-definition multimedia interface (HDMI), etc.

In one or more embodiments, the storage/memory resource (204) may store data structures including, for example (but not limited to): composed system data, a resource map, a computing resource health repository, application data, etc.

In one or more embodiments, the composed system data may be implemented using one or more data structures that includes information regarding composed IHSs. For example, the composed system data may specify identifiers of composed IHSs, and resources that have been allocated to the composed IHSs.

The composed system data may also include information regarding the operation of the composed IHSs. The information (which may be utilized to manage the operation of the composed IHSs) may include (or specify), for example (but not limited to): workload performance data, resource utilization rates over time, management models employed by the processor (208), etc. For example, the composed system data may include information regarding duplicative data stored for data integrity purposes, redundantly performed workloads to meet high-availability service requirements, encryption schemes utilized to prevent unauthorized access of data, etc. Data (e.g., duplicate data and/or deduplicated data stored to the storage/memory resource (204)) may be tracked (e.g., by the processor (208)) using one or more VSBs.

The composed system data may be maintained by, for example, a composition manager (e.g., of IHS A (200A)). For example, the composition manager may add, remove, and/or modify information included in the composed system data to cause the information included in the composed system data to reflect the state of the composed IHSs. The data structures of the composed system data may be implemented using, for example, lists, tables, unstructured data, databases, etc. While illustrated as being stored locally, the composed system data may be stored remotely and may be distributed across any number of devices without departing from the scope of the embodiments disclosed herein.

In one or more embodiments, the resource map may be implemented using one or more data structures that include information regarding resources of IHS A (200A) and/or other IHSs. For example, the resource map may specify the type and/or quantity of resources (e.g., hardware devices, virtualized devices, etc.) available for allocation and/or that are already allocated to composed IHSs. The resource map may be used to provide data to management entities.

The data structures of the resource map may be implemented using, for example, lists, tables, unstructured data, databases, VSBs, etc. While illustrated as being stored locally, the resource map may be stored remotely and may be distributed across any number of devices without departing from the scope of the embodiments disclosed herein. The resource map may be maintained by, for example, the composition manager. For example, the composition manager may add, remove, and/or modify information included in the resource map to cause the information included in the resource map to reflect the state of IHS A (200A) and/or other IHSs.

In one or more embodiments, the computing resource health repository may be implemented using one or more data structures that includes information regarding the health of hardware devices that provide computing resources to composed IHSs. For example, the computing resource health repository may specify operation errors, health state information, temperature, and/or other types of information indicative of the health of hardware devices.

The computing resource health repository may specify the health states of hardware devices via any method. For example, the computing resource health repository may indicate whether, based on the aggregated health information, that the hardware devices are or are not in compromised states. A compromised health state may indicate that the corresponding hardware device has already or is likely to, in the future, be no longer able to provide the computing resources that it has previously provided. The health state determination may be made via any method based on the aggregated health information without departing from the scope of the embodiments disclosed herein. For example, the health state determination may be made based on heuristic information regarding previously observed relationships between health information and future outcomes (e.g., current health information being predictive of whether a hardware device will be likely to provide computing resources in the future).

The computing resource health repository may be maintained by, for example, the composition manager. For example, the composition manager may add, remove, and/or modify information included in the computing resource health repository to cause the information included in the computing resource health repository to reflect the current health of the hardware devices that provide computing resources to the composed IHSs.

The data structures of the computing resource health repository may be implemented using, for example, lists, tables, unstructured data, databases, etc. While illustrated as being stored locally, the computing resource health repository may be stored remotely and may be distributed across any number of devices without departing from the scope of the embodiments disclosed herein.

While the storage/memory resource (204) has been illustrated and described as including a limited number and type of data, the storage/memory resource (204) may store additional, less, and/or different data without departing from the scope of the embodiments disclosed herein. One of ordinary skill will appreciate that the storage/memory resource (204) may perform other functionalities without departing from the scope of the embodiments disclosed herein. The storage/memory resource (204) may be implemented using hardware, software, or any combination thereof.

In one or more embodiments, the BIOS (210) may refer to any system, device, or apparatus configured to (i) identify, test, and/or initialize information handling resources (e.g., NIC A (212A), other hardware components of IHS A (200A), etc.) of IHS A (200A) (typically during boot up or power on of IHS A (200A)), and/or initialize interoperation of IHS A (200A) with other IHSs, and (ii) load a boot loader or an OS (e.g., the OS (206) from a mass storage device). The BIOS (210) may be implemented as a program of instructions (e.g., firmware, a firmware image, etc.) that may be read by and executed on the processor (208) to perform the functionalities of the BIOS (210).

In one or more embodiments, the BIOS (210) may include boot firmware configured to be the first code executed by the processor (208) when IHS A (200A) is booted and/or powered on. As part of its initialization functionality, the boot firmware may be configured to set hardware components of IHS A (200A) into a known state, so that one or more applications (e.g., the OS (206) or other applications) stored on the storage/memory resource (204) may be executed by the processor (208) to provide computer-implemented services to one or more users of a client (e.g., 110A, FIG. 1). Further, the BIOS (210) may provide an abstraction layer for some of the hardware components of IHS A (200A), such as a consistent way for applications and OSs to interact with a keyboard, a display, and other input/output components.

One of ordinary skill will appreciate that the BIOS (210) may perform other functionalities without departing from the scope of the embodiments disclosed herein. The BIOS (210) may be implemented using hardware, software, or any combination thereof.

In one or more embodiments, as being an in-band network interface device/component, NIC A (212A) may include one or more systems, apparatuses, or devices that enable the host system (202) to communicate and/or interface with other devices (including other host systems), services, and components that are located externally to IHS A (200A). These devices, services, and components, such as one or more transceivers, may interface with the host system (202) via an external network (e.g., a shared network, a data network, an in-band network, etc.), such as the in-band connection (224) (that provides in-band access), which may include a LAN, a WAN, a PAN, the Internet, etc.

In one or more embodiments, NIC A (212A) may enable the host system (202) to communicate using any suitable transmission protocol and/or standard and NIC A (212A) may be enabled as a LAN-on-motherboard (LOM) card.

One of ordinary skill will appreciate that NIC A (212A) may perform other functionalities without departing from the scope of the embodiments disclosed herein. NIC A (212A) may be implemented using hardware, software, or any combination thereof.

As used herein, a “transceiver” (or a “transceiver module”) may represent a hardware component, a software component, or any combination thereof (e.g., a combination of a transmitter and a receiver in a single package) of a NIC that transmits and receives signals over a network (or a network wire/cable) to enable/support data transmission between various computing devices (e.g., peripheral devices, storage devices, etc.). For example, a transceiver of NIC A (212A) may communicate with one or more transceivers of another NIC (of another IHS (e.g., IHS N (e.g., 120N, FIG. 1)) that is connected to IHS A (200A)) to support data (e.g., VSBs) transmission between IHS A (200A) and IHS N using a wide variety of communications interface standards.

In one or more embodiments, as being a specialized processing unit (if, for example, IHS A (200A) is a server) or an embedded controller (if, for example, IHS A (200A) is a user-level device) different from a CPU (e.g., the processor (208)), the BMC (220) may be configured to provide management/monitoring functionalities (e.g., power management, cooling management, etc.) for the management of IHS A (200A) (e.g., the hardware components and firmware in IHS A (200A), such as the BIOS firmware, the UEFI firmware, etc.). Such management may be made even if IHS A (200A) is powered off or powered down to a standby state. The BMC (220) may also, e.g.: (i) determine when one or more computing components are powered up, (ii) be programmed using a firmware stack (e.g., an iDRAC® firmware stack) that configures the BMC (220) for performing out-of-band (e.g., external to the BIOS (210)) hardware management tasks, (iii) collectively provide a system for monitoring the operations of IHS A (200A) as well as controlling certain aspects of IHS A (200A) for ensuring its proper operation, (iv) obtain computing resource capacity and availability of IHS A (200A), (v) obtain health data/statistics of each component of IHS A (200A), and/or (vi) obtain individual computing resource utilization patterns of each component of IHS A (200A).

In one or more embodiments, the BMC (220) may include (or may be an integral part of), for example (but not limited to): a chassis management controller (CMC), a remote access controller (e.g., a DRAC® or an iDRAC®), one-time programmable (OTP) memory (e.g., special non-volatile memory that permits the one-time write of data therein—thereby enabling immutable data storage), a boot loader, etc. The BMC (220) may be accessed by an administrator of IHS A (200A) via a dedicated network connection (i.e., the out-of-band connection (226)) or a shared network connection (i.e., the in-band connection (224)).

In one or more embodiments, as shown in FIG. 2, the BMC (220) may be a part of an integrated circuit or a chipset within IHS A (200A). Separately, the BMC (220) may operate on a separate power plane from other components in IHS A (200A). Thus, the BMC (220) may communicate with the corresponding management system via its network interface while the resources/components of IHS A (200A) are powered off.

In one or more embodiments, the boot loader may refer to a boot manager, a boot program, an initial program loader (IPL), or a vendor-proprietary image that has a functionality to, e.g.: (i) load a user's kernel from persistent storage into the main memory (or the working memory) of IHS A (200A), (ii) perform security checks for one or more hardware components of IHS A (200A), (iii) guard the device state of one or more hardware components of IHS A (200A), (iv) boot IHS A (200A), (v) ensure that all relevant OS data and other applications are loaded into the main memory of IHS A (200A) (and ready to execute) when IHS A (200A) is started, (vi) based on (v), irrevocably transfer control to the OS (206) and terminate itself, (vii) include any type of executable code for launching or booting a custom BMC firmware stack on the BMC (220), (viii) include logic for receiving user input for selecting which operational parameters may be monitored and/or processed by a coprocessor, and/or (ix) include a configuration file that may be edited for selecting (by a user) which operational parameters may be monitored and which operational parameters may be managed by a coprocessor.

One of ordinary skill will appreciate that the BMC (220) may perform other functionalities without departing from the scope of the embodiments disclosed herein. The BMC (220) may be implemented using hardware, software, or any combination thereof.

In one or more embodiments, the BMC (220) may include/host a database (not shown). The database may provide long-term, durable, high read/write throughput data storage/protection with near-infinite scale and low-cost. The database may be a fully managed cloud/remote (or local) storage (e.g., cold tier storage, pluggable storage, object storage, block storage, file system storage, data stream storage, Web servers, unstructured storage, etc.) that acts as a shared storage/memory resource that is functional to store unstructured and/or structured data. Further, the database may also occupy a portion of a physical storage/memory device or, alternatively, may span across multiple physical storage/memory devices.

In one or more embodiments, the database may be implemented using physical devices that provide data storage services (e.g., storing data and providing copies of previously stored data). The devices that provide data storage services may include hardware devices and/or logical devices. For example, the database may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database may include a memory device (e.g., a dual in-line memory device), in which data is stored and from which copies of previously stored data are provided. As yet another example, the database may include a persistent storage device (e.g., an SSD), in which data is stored and from which copies of previously stored data is provided. As yet another example, the database may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, an application of applications (215) may be software (or a software program) executing on the host system (202) that includes instructions (e.g., data, implementation details, code, etc.) which, when executed by the processor (208), initiate the performance of one or more operations/services, for example, to be delivered to a user of a corresponding client (e.g., 110A, FIG. 1). An application of applications (215) may provide less, the same, or more functionalities and/or services comparing applications executing on a client (e.g., 110N, FIG. 1). One of ordinary skill will appreciate that the application may perform other functionalities without departing from the scope of the embodiments disclosed herein.

In one or more embodiments, IHS A (200A) may include one or more additional hardware components, not shown for clarity. For example, IHS A (200A) may include additional storage devices (that may have or provide functionalities and/or characteristics of the storage or memory resources described above in reference to FIG. 1) for storing machine-executable code (e.g., software, data, etc.), a platform controller hub (PCH) (e.g., to control certain data paths (e.g., system buses, data flow, etc.) between at least the processor (208) and peripheral devices), one or more communications ports for communicating with external devices as well as various input/output devices, one or more power supply units (PSUs) (e.g., to power hardware components of IHS A (200A)), different types of sensors (e.g., temperature sensors, voltage sensors, etc.) (that report to the BMC (220) about parameters such as temperature, cooling fan speeds, a power status, an OS status, etc.), additional CPUs and bus controllers, a display device, one or more environmental control components (e.g., cooling fans), one or more fan controllers within the BMC (220), an additional processor (e.g., a coprocessor) within the BMC (220), a BMC update module, and a component firmware update module (located, for example, within the processor (208)).

In one or more embodiments, the BMC (220) may monitor one or more sensors and send alerts to an administrator of IHS A (200A) if any of the parameters do not stay within predetermined limits, indicating a potential failure of IHS A (200A). The administrator may also remotely communicate with the BMC (220) to take particular corrective actions, such as resetting or power cycling IHS A (200A).

In one or more embodiments, the storage/memory resource (204), the processor (208), the BIOS (210), NIC A (212A), the applications (215), and the BMC (220) may be utilized in isolation and/or in combination to provide the above-discussed functionalities. These functionalities may be invoked using any communication model including, for example, message passing, state sharing, memory sharing, etc.

Further, some of the above-discussed functionalities may be performed using available resources or when resources of IHS A (200A) are not otherwise being consumed. By performing these functionalities when resources are available, these functionalities may not be burdensome on the resources of IHS A (200A) and may not interfere with more primary workloads performed by IHS A (200A).

Turning now to FIGS. 3.1-3.3, FIGS. 3.1-3.3 show visual representations of example VSBs in accordance with one or more embodiments disclosed herein. Referring to FIG. 3.1, a VSB (300) is shown as having three levels: Level One (L1) (301), Level Two (L2) (307), and Level Three (L3) (309). The VSB (300) may be represented as a pointer tree, in which the pointer tree is a representation of the VSB (300) in a hierarchical structure. In a pointer tree, one or more bits of the VSB (300) may be represented in blocks that are connected across different levels (e.g., L1, L2, etc.) using a special pointer(s) (e.g., a real pointer (illustrated by a half dashed arrow), a zero (0) pointer, a maximum pointer (e.g., an “FF” pointer), etc.).

As used herein, a zero pointer may indicate that all bits included in a given block (e.g., L1—First Block (311A), FIG. 3.1) are set/reset to zero. As used herein, a maximum (max) pointer (e.g., “FF” in hexadecimal (“11111111” in binary), see FIG. 3.3) may indicate that all bits included in a given block (e.g., L2—Third Block (315B), FIG. 3.3) are set to one. While FF is used to symbolize the max pointer, the max pointer is described by 0xFFFF . . . where the amount of Fs corresponds to the number of bits set (i.e., 0xFF is eight bits and 0xFFFFFFFF is 32 bits, etc.). Further, as used herein, a real pointer may be a pointer that points from a block (e.g., L1—Second Block 313A) to a related block set (e.g., a second block set (304)) in the pointer tree.

In one or more embodiments, the pointer tree may include a root block (not shown) at Level Zero (not shown) that is a level above L1 (301), in which the root block includes all the information/data (e.g., blocks, bits specified in those blocks, one or more special pointers, etc.) specified in the remaining levels (e.g., L1, L2, L3, etc.) of the pointer tree. The root block is connected to a first block set (302) on L1 (301) by a pointer (not shown).

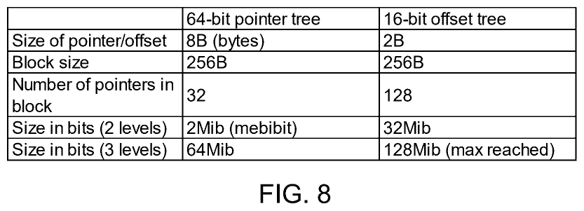

In one or more embodiments, two or more blocks included in the first block set (302) may be tunable to increase or decrease a size of a corresponding block in order to manage data I/O efficiency of memory (e.g., 204, FIG. 2). Similarly, a special pointer may be tunable to increase or decrease a size of the pointer in order to manage data I/O efficiency of the memory. Additional details of tunability are described below in reference to FIG. 8.

Referring to FIG. 3.1, one or more special pointers (e.g., zero pointers) may cause the VSB (300) to have a low memory structure. In one or more embodiments, a zero pointer or a max pointer may replace a corresponding block set (e.g., a second block set (304)) to free up memory (e.g., 204, FIG. 2).

In one or more embodiments, L1 (301) may include the first block set (302), in which the first block set (302) may host one or more blocks (e.g., L1—First Block (311A), L1—Second Block (313A), L1—Third Block (315A), L1—Fourth Block (317A), etc.). L1—First Block (311A) may include a zero pointer, indicating that all bits included in L1—First Block (311A) are set/reset to zero. L1—Second Block (313A) may include a first pointer (305A) (e.g., a real pointer) connecting L1—Second Block (313A) to a second block set (304). Further, L1—Third Block (315A) and L1—Fourth Block (317A) may also include zero pointers, indicating that all bits included in each block are set/reset to zero.

In one or more embodiments, L2 (307) may include one or more blocks (e.g., the second block set (304)) that are referenced by a corresponding block (e.g., L1—Second Block (313A)) of L1 (301). As indicated in FIG. 3.1, L1—First Block (311A), L1—Third Block (315A), and L1—Fourth Block (317A) are not connected to L2 (307) because each of these blocks includes a zero pointer, in order to reduce memory that would be required to store all the bits that are set/reset to zero.

Further, in reference to FIG. 3.1, (i) each of L2—First Block (311B) and L2—Second Block (313B) may include a zero pointer, (ii) L2—Third Block (315B) may include a second “real” pointer (305B) connecting L2—Third Block (315B) to a third block set (306), and (iii) L2—Fourth Block (317B) may also contain a zero pointer.

In one or more embodiments, L3 (309) may include one or more blocks (e.g., the third block set (306)) that are referenced by a related block (e.g., L2—Third Block (315B)) of L2 (307). As indicated in FIG. 3.1, (i) L3—First Block (311C) may include a zero pointer, (ii) L3—Second Block (313C) may include “0600” (where (a) “0600” is shown in a hexadecimal notation and corresponds to “0000011000000000” in binary and (b) “0600” indicates that two bits are set to one (in binary) and the remaining bits are reset to zero), and (iii) each of L3—Third Block (315C) and L3—Fourth Block (317C) may also include a zero pointer.

Referring FIG. 3.1, L3 (309) is the lowest level (e.g., the base level) in the VSB (300), including the actual bits of the bit-array. L3 (309) may include one or more blocks (e.g., the third block set (306)), in which each block in L3 (309) may include 16 bits. Considering all the levels of the pointer tree (e.g., L1-L3), a total number of bits in the pointer tree is equal to 1024 (16 bits (from L3)×four blocks (from L3)×four blocks (from L2)×four blocks (from L1)=1024). As indicated, using zero pointers (e.g., replacing the bits in a corresponding level with zero pointers) may decrease the amount of memory needed to define the VSB (300).

Referring to FIG. 3.2, VSB (320) is shown as having three levels: L1 (301), L2 (307), and L3 (309). The VSB (320) may be represented as a pointer tree, in which the pointer tree is a representation of the VSB (320) in a hierarchical structure. The VSB (320) is similar to the VSB (300) referenced in FIG. 3.1 but includes two block sets at L3 (309) (e.g., the third block set (306) and a fourth block set (308)). As with the VSB (300) referenced in FIG. 3.1, one or more special pointers (e.g., zero pointers) may cause the VSB (320) to have a low memory structure. In one or more embodiments, a zero pointer or a max pointer may replace a corresponding block set (e.g., a second block set (304)) to free up memory (e.g., 204, FIG. 2).

In one or more embodiments, L1 (301) of the VSB (320) may be the same as the VSB (300). L1 includes the first block set (302), in which the first block set (302) may host one or more blocks (e.g., L1—First Block (311A), L1—Second Block (313A), L1—Third Block (315A), L1—Fourth Block (317A), etc.). L1—First Block (311A) may include a zero pointer, indicating that all bits included in L1—First Block (311A) are set/reset to zero. L1—Second Block (313A) may include a first pointer (305A) (e.g., a real pointer) connecting L1—Second Block (313A) to a second block set (304). Further, L1—Third Block (315A) and L1—Fourth Block (317A) may also include zero pointers, indicating that all bits included in each block are set/reset to zero.

In one or more embodiments, L2 (307) of the VSB (320) may include one or more blocks (e.g., the second block set (304)) that are referenced by a corresponding block (e.g., L1—Second Block (313A)) of L1 (301). As indicated in FIG. 3.2, L1—First Block (311A), L1—Third Block (315A), and L1—Fourth Block (317A) are not connected to L2 (307) because each of these blocks include a zero pointer, in order to reduce memory that would be required to store all the bits that are set/reset to zero.

Further, in reference to FIG. 3.2, (i) each of L2—First Block (311B) and L2—Second Block (313B) may include a zero pointer, (ii) L2—Third Block (315B) may include a second “real” pointer (305B) connecting L2—Third Block (315B) to a third block set (306), and (iii) L2—Fourth Block (317B) may include a third “real” pointer (305C) connecting L2—Fourth Block (317B) to a fourth block set (308).

In one or more embodiments, L3 (309) may include one or more blocks (e.g., the third block set (306) and the fourth block set (308)) that are referenced by a related block (e.g., L2—Third Block (315B) and L2—Fourth Block (317B)) of L2 (307). As indicated in FIG. 3.2, regarding the third block set (306), (i) L3—First Block (311C) may include a zero pointer, (ii) L3—Second Block (313C) may include “0600” (where (a) “0600” is shown in a hexadecimal notation and corresponds to “0000011000000000” in binary and (b) “0600” indicates that two bits are set to one (in binary) and the remaining bits are reset to zero), and (iii) each of L3—Third Block (315C) and L3—Fourth Block (317C) may also include a zero pointer.

Further, in FIG. 3.2, regarding to the fourth block set (308), (i) L3—Fifth Block (311D) may include a zero pointer, (ii) L3—Sixth Block (313D) may include “0101” (where (a) “0101” is shown in a hexadecimal notation and corresponds to “0000000100000001” in binary and (b) “0101” indicates that two bits are set to one (in binary) and the remaining bits are reset to zero), and (iii) each of L3—Seventh Block (315D) and L3—Eight Block (317D) may also include a zero pointer. With two bits set in the third block set (306) and two bits set in the fourth block set (308), the total amount of bits set in the VSB (320) is four bits.

Referring to FIG. 3.2, L3 (309) is the lowest level (e.g., a base level) in the VSB (320) including the actual bits of the bit-array. L3 (309) may include one or more blocks (e.g., the third block set (306) and the fourth block set (308)), in which each block in L3 (309) may include 16 bits. Considering all the levels of the pointer tree (e.g., L1-L3), a total number of bits in the pointer tree is equal to 1024 (16 bits (from L3)×four blocks (per each block set on L3)×four blocks (from L2)×four blocks (from L1)=1024). As indicated, using zero pointers (e.g., replacing the bits in a corresponding level with zero pointers) may decrease the amount of memory needed to define the VSB (320).

Referring to FIG. 3.3, VSB (330) is shown as having two levels: L1 (301) and L2 (307). The VSB (330) may be represented as a pointer tree, in which the pointer tree is a representation of the VSB (330) in a hierarchical structure. The VSB (330) is similar to the VSB (300) referenced in FIG. 3.1 but includes two levels (e.g., L1 (301) and L2 (307)). As with the VSB (300) referenced in FIG. 3.1, one or more special pointers (e.g., zero pointers) may cause the VSB (330) to have a low memory structure. In one or more embodiments, a zero pointer or a max pointer may replace a corresponding block set (e.g., a second block set (304)) to free up memory (e.g., 204, FIG. 2).

In one or more embodiments, L1 (301) of the VSB (330) may be the same as the VSB (300). L1 includes the first block set (302), in which the first block set (302) may host one or more blocks (e.g., L1—First Block (311A), L1—Second Block (313A), L1—Third Block (315A), L1—Fourth Block (317A), etc.). L1—First Block (311A) may include a zero pointer, indicating that all bits included in L1—First Block (311A) are set/reset to zero. L1—Second Block (313A) may include a first pointer (305A) (e.g., a real pointer) connecting L1—Second Block (313A) to a second block set (304). Further, L1—Third Block (315A) and L1—Fourth Block (317A) may also include zero pointers, indicating that all bits included in each block are set/reset to zero.

In one or more embodiments, L2 (307) of the VSB (330) may include one or more blocks (e.g., the second block set (304)) that are referenced by a corresponding block (e.g., L1—Second Block (313A)) of L1 (301). As indicated in FIG. 3.3, L1—First Block (311A), L1—Third Block (315A), and L1—Fourth Block (317A) are not connected to L2 (307) because each of these blocks includes a zero pointer, in order to reduce memory that would be required to store all the bits that are set/reset to zero.

Further, in reference to FIG. 3.3, (i) each of L2—First Block (311B) and L2—Second Block (313B) may include a zero pointer, (ii) each of L2—Third Block (315B) and L2—Fourth Block (317B) may include a max pointer (where (a) a max pointer indicates each block is completely set and (b) the max pointer is symbolized by “FF”).

In one or more embodiments, referring to FIG. 3.3, L2 (307) is the lowest level (e.g., a base level) in the VSB (330) including the actual bits of the bit-array. With L2 being the base level, the max pointers in L2—Third Block (315B) and L2—Fourth Block (317B) correspond to the actual bits contained in each block and each block contains 16 bits. Therefore, “FF” in blocks L2—Third Block (315B) and L2—Fourth Block (317B) corresponds to all 16 bits in each block being set to one. Therefore, 32 bits are set to one in the VSB (330). Considering all the levels of the pointer tree (e.g., L1-L2), a total number of bits in the pointer tree is equal to 256 (16 bits (from L2)×four blocks (per each block set on L2)×four blocks (per each block set on L1)=256). As indicated, using zero pointers (e.g., replacing the bits in a corresponding level with zero pointers) may decrease the amount of memory needed to define the VSB (330).

However, in other embodiments, the pointer tree (discussed in FIG. 3.3) may have a level three (as the base level), which is not visually represented because of all the blocks on L2 (307) (e.g., L2—First Block (311B), L2—Second Block (313B), L2—Third Block (315B), and L2—Fourth Block (317B)) being completely set/reset by including zero pointers and/or max pointers. In these embodiments, L2—Third Block (315B) may connect to a third block set (see e.g., the third block set (306), FIG. 3.1), which is completely set and contains 64 bits set to one (e.g., a third block set that includes four blocks with 16 bits in each block of the block set). L2—Fourth Block (317B) may connect to a fourth block set (see e.g., the fourth block set (308), FIG. 3.2), which is completely set and contains 64 bits set to one (e.g., a fourth block set that includes four blocks with 16 bits in each block of the block set). The total bits set to one in the VSB (330) may be 128 bits, with 64 bits considered from the third block set and 64 bits considered from the fourth block set. The total amount of bits in VSB (330) may be 1024 bits (as shown in FIG. 3.1 with respect to the VSB (300)).

In one or more embodiments, referring to FIGS. 3.1-3.3, operations may be performed on a given VSB (e.g., VSB (300), VSB (320), VSB (330)). These operations may include an “AND” operation (i.e., a logical AND operation), an “OR” operation (i.e., a logical inclusive OR operation), an “exclusive or” (XOR) operation (i.e., a logical XOR operation), a “NOT” operation (i.e., a logical NOT operation), and/or other bitwise operations. When performing an operation, two bit-arrays may be used, and at least one of the bit-arrays can be a VSB. To perform an operation, corresponding pointer trees of the bit-arrays can be traversed to determine which bits need to be changed as indicated by the operation. The indicated bits may be then set/reset. When performing an operation, the number of bits to be set/reset may be proportional to the number of bits set in the VSB. Traversing the pointer tree and setting/resetting the bits is discussed further in FIGS. 5 and 6.

In one or more embodiments, a special operation may be used to set/reset all bits on a VSB. Setting/resetting all the bits frees (i.e., deallocates) all blocks in a VSB except for the root block. Because all other blocks are deallocated, the bits are all set/reset in the root block. Deallocation of blocks is discussed further in FIG. 6.

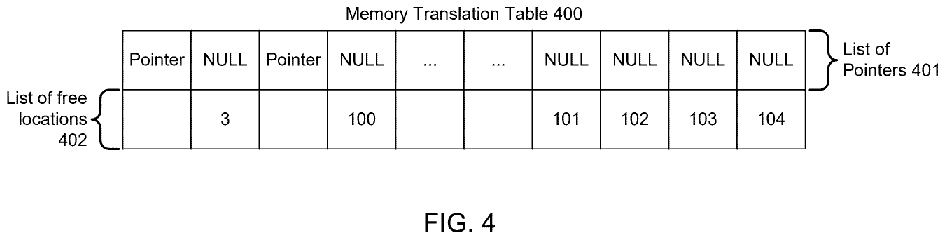

Turning now to FIG. 4, FIG. 4 shows a memory translation table (400) for converting a VSB from a pointer tree to an offset tree in accordance with one or more embodiments disclosed herein. Referring to FIG. 3.1, a VSB (300) is defined as a pointer tree. In contrast to a pointer tree, an offset tree may use one or more offsets instead of pointers. Each offset (e.g., an offset pointer) may represent a specific offset in a corresponding VSB (e.g., “Offset 0” represents a group of bits starting at the zeroth bit, “Offset 8” represents a group of bits starting at the eighth bit, etc.). Further, a root block of an offset tree may include all the bits (similar to the pointer tree) and be defined as “Offset 0” with no other offsets present in the offset tree.

In one or more embodiments, an offset tree may be used when a VSB needs to be persistent (e.g., remains accessible until the VSB is intentionally deleted or overwritten (e.g., during a system shutdown and/or restart)). An offset tree can be hardened (i.e., securely stored for later retrieval). The offset tree may also be stored on the disk of the system containing the offset tree.

Further, to complete the transition/conversion from a pointer tree to an offset tree, pointers of the pointer tree is replaced by offsets (in the offset tree). The offsets may be smaller (in terms of size) than the pointers as shown in FIG. 8. In one or more embodiments, there may be one or more ways to convert a pointer tree to an offset tree. For example, corresponding memory can be pre-allocated to a VSB in order to support the formation of the VSB and the VSB's functionalities. If the memory is pre-allocated, a related pointer tree can be converted to an offset tree (e.g., by restructuring the pointer tree to replace the pointers with offsets that represent a range of bits of corresponding VSB). As yet another example, the memory may not be pre-allocated and, for this reason, the memory translation table (400) can be used.

Referring to FIG. 4, the memory translation table (400) may include a list of pointers (401) and a list of free locations (402). In one or more embodiments, the list of pointers (401) may be used to determine a next pointer (of a related pointer tree) to be replaced by an offset. The list of free locations (402) may be a list of locations in memory that can be allocated to accommodate a set of newer offsets. The size of the memory translation table (400) may be limited by the maximum number of blocks that the pointer tree can include/host. Once the memory is allocated, the pointer tree may be converted to an offset tree by replacing the list of pointers (401) with related offsets.

In one or more embodiments, as performed on a given pointer tree, one or more bitwise operations (see FIGS. 3.1-3.3) can also be performed on a given offset tree. When updating bits of the offset tree (using a bitwise operation), corresponding offsets may need to be updated in a reverse order (e.g., from a last offset in the offset tree to Offset 0 of the offset tree). Further, when all the bits in an offset tree are set/reset, only the root block (i.e., Offset 0) of the offset tree may need to be updated.

In one or more embodiments, since the offset tree is persistent, an update/change log may be used to log updates (e.g., changing/updating bits by employing one or more bitwise operations) to the offset tree. The change log may prevent a related VSB from being hardened (i.e., made persistent) after every update made to the VSB. Instead, the change log may be hardened and, after a period of time, the VSB may be hardened based on the changes stored in the change log.

In one or more embodiments, compared to an offset tree, a pointer tree may use memory more efficiently; however, the offset tree may provide longer persistency of data (e.g., offset trees can be used when data needs to be persistent).

Turning now to FIG. 5, FIG. 5 shows a flow diagram describing a method of adjusting bits in a VSB in accordance with one or more embodiments disclosed herein. The method of FIG. 5 may be performed by, for example, the engine (e.g., 230, FIG. 2) and the processor (e.g., 208, FIG. 2). Other components of the system of FIG. 1 may perform all, or a portion, of the method of FIG. 5 without departing from the disclosure.

While the various steps in the flowcharts are presented and described sequentially, one of ordinary skill in the relevant art will appreciate that some or all of the steps may be executed in different orders, may be combined, or omitted, and some or all steps may be executed in parallel.

In Step 500, the processor identifies a block containing a bit to be set/reset. In one or more embodiments, the block may be part of a VSB (which is managed by the engine). Because of the hierarchical tree structure of the VSB, the bit to be set/reset may be pointed by a corresponding block (via a pointer, see e.g., FIG. 3.1) in a given level (e.g., L2, FIG. 3.1). The processor may discover a position of the bit through related pointers, indicating that the processor identifies a related block (on each level) that corresponds to the bit.

In some embodiments, the processor may discover the location/position of the bit using (by employing) a depth first search (DFS) algorithm/model. In one scenario, in some embodiments, the processor may analyze a root block (of the VSB) and a first block set (e.g., 302, FIG. 3.1) of the VSB. As a result of the analysis, the processor may determine/identify that the bit is not included in a first block (e.g., L1—First Block (311A), FIG. 3.1) of the first block set and, based on the determination, the processor may switch to a second block (e.g., L1—Second Block (313A), FIG. 3.1) of the first block set. Thereafter, the processor may determine that the bit is included in a second block.

In Step 502, based on Step 500, the processor makes a first determination (in real-time or near real-time) as to whether the block is completely set (e.g., a block is considered as “completely set” when each bit in the block is set to one) or completely reset (e.g., the block is considered as “completely reset” when each bit in the block is reset to zero). Accordingly, in one or more embodiments, if the result of the first determination is YES, the method proceeds to Step 504. If the result of the first determination is NO, the method alternatively proceeds to Step 506.

In Step 504, as a result of the first determination in Step 502 being YES (e.g., the second block is completely set), the processor allocates a new block set (e.g., the second block set (304), FIG. 3.1) to a related next level (e.g., L2 (307), FIG. 3.1). In one or more embodiments, the new block set may be connected to the block (e.g., L1—Second Block 313A, FIG. 3.1) by a pointer (e.g., a first pointer (305A), FIG. 3.1), which replaces a zero pointer (that previously indicating that the block was completely reset) or a max pointer (that previously indicated that the block was completely set) in the VSB. To this end, in the above scenario (discussed in Step 500), the second block may be considered including all the data related to the second block set (via the first pointer). Thereafter, the method may proceed to Step 506.

In Step 506, as a result of the first determination in Step 502 being NO or proceeding from Step 504, the processor traverses the next level (e.g., L2 (307), FIG. 3.1) using the pointer (e.g., the first pointer (305A), FIG. 3.1). In one or more embodiments, the processor may traverse the new block set (allocated in Step 504) in the next level using the pointer. In other embodiments, the processor may traverse an existing block set (e.g., the second block set) determined as existed in Step 502 (via the first pointer). Continuing with the discussion of the above scenario (discussed in Step 500), the processor may move/switch from the second block to the second block set using the first pointer.

In Step 508, based on Step 506, the processor makes a second determination (in real-time or near real-time) as to whether the next level is a base level that includes the bit. Accordingly, in one or more embodiments, if the result of the second determination is YES, the method proceeds to Step 510. If the result of the second determination is NO, the method alternatively returns to Step 500 (e.g., to find a corresponding block that includes the bit in a related block set).

As discussed above, the base level may be the level of the VSB, in which (i) the bits are present without another level of abstraction and (ii) the bits can be individually set or reset.

In Step 510, as a result of the second determination in Step 508 being YES (e.g., the second block set is at the base level in the aforementioned scenario), the processor sets or resets the bit. In one or more embodiments, the processor may determine which block in the corresponding block set contains the bit and then, set or reset the bit. Returning to the above scenario (specified in Step 500), the processor may determine that the bit is in the second block of the second block set. Based on the determination, the processor may change the bit to zero (e.g., resetting the bit). The method may end after Step 510.

The traversal of the levels as shown in FIG. 5 may be performed using the DFS algorithm/model (e.g., the processor may traverse through all the levels (in the VSB) before returning to the first level and checking the next block across all the levels). Separately, the DFS algorithm/model can also be employed (by the processor) to perform the method discussed below in reference to FIG. 6.

Turning now to FIG. 6, FIG. 6 shows a flow diagram describing a method of adjusting bits in a VSB in accordance with one or more embodiments disclosed herein. The method of FIG. 6 may be performed by, for example, the engine (e.g., 230, FIG. 2) and the processor (e.g., 208, FIG. 2). Other components of the system of FIG. 1 may perform all, or a portion, of the method of FIG. 6 without departing from the disclosure.

While the various steps in the flowcharts are presented and described sequentially, one of ordinary skill in the relevant art will appreciate that some or all of the steps may be executed in different orders, may be combined, or omitted, and some or all steps may be executed in parallel.

In Step 600, the processor identifies a block containing a bit to be set/reset. In one or more embodiments, the block may be part of a VSB (which is managed by the engine). Because of the hierarchical tree structure of the VSB, the bit to be set/reset may be pointed by a corresponding block (via a pointer, see e.g., FIG. 3.1) in a given level (e.g., L2, FIG. 3.1). The processor may discover a position of the bit through related pointers, indicating that the processor identifies a related block (on each level) that corresponds to the bit.

In some embodiments, the processor may discover the location/position of the bit using (by employing) the DFS model. In one scenario, in some embodiments, the processor may analyze a root block (of the VSB) and a first block set (e.g., 302, FIG. 3.1) of the VSB. As a result of the analysis, the processor may determine/identify that the bit is not included in a first block (e.g., L1—First Block (311A), FIG. 3.1) of the first block set and, based on the determination, the processor may switch to a second block (e.g., L1—Second Block (313A), FIG. 3.1) of the first block set. Thereafter, the processor may determine that the bit is included in the second block.

In step 602, the processor traverses a block set (e.g., the second block set (304), FIG. 3.1) in the next level (e.g., L2 (307), FIG. 3.1) using a pointer (e.g., the first pointer (305A), FIG. 3.1). The pointer connects the corresponding block from Step 600 to the block set on the next level. Continuing with the discussion of the above scenario, the processor may move/switch from the second block to the second block set on L2 using the first pointer.

In Step 604, based on Step 602, the processor makes a determination (in real-time or near real-time) as to whether the next level is a base level that includes the bit. Accordingly, in one or more embodiments, if the result of the determination is YES, the method proceeds to Step 606. If the result of the determination is NO, the method alternatively returns to Step 600 (e.g., to find a corresponding block that includes the bit in a related block set).

As discussed above, the base level may be the level of the VSB, in which (i) the bits are present without another level of abstraction and (ii) the bits can be individually set or reset.

In Step 606, as a result of the determination in Step 604 being YES (e.g., the second block set is at the base level in the aforementioned scenario), the processor sets or resets the bit to make all bits uniform in the block set of the base level. The bit to be set or reset is determined by the processor and is set or reset. In one or more embodiments, the processor may determine which block in the corresponding block set contains the bit and then, set or reset the bit. The processor then makes a second determination that setting/resetting the bit causes all bits in the corresponding block set to be completely set (e.g., a block is considered as “completely set” when each bit in the block is set to one) or completely reset (e.g., the block is considered as “completely reset” when each bit in the block is reset to zero). Returning to the above scenario (specified in Step 600), the processor may determine that the bit is in the second block of the second block set. Based on the determination, the processor may change the bit to zero (e.g., resetting the bit). By resetting the bit, the processor has made all bits in the second block set zero (completely resetting the second block set).

In Step 608, the processor deallocates the block set. Based on the second determination that the block set is completely set or completely reset, the processor deallocates the block set because the block set can be identified by a zero pointer or a max pointer in the block connected to the block set. Deallocating the block set reduces the memory consumption of the VSB. Returning to the above scenario (specified in Step 600), the processor removes the second block set from L2 of the VSB because all bits in the second block set are reset to zero.

In Step 610, the processor removes the pointer from the block that was connected to the block set. The pointer is removed to be replaced by the zero pointer or the max pointer that indicates the block is either completely reset or completely set, respectively. Returning to the above scenario (specified in Step 600), the processor removes the first pointer from the second block.

In Step 612, the processor places a zero pointer (0) or a max pointer (FF) in the block. The block may be filled with a zero pointer (0) if the block is completely reset. Separately, the block may be filled with a max pointer if the block is completely set. By replacing the block set with a zero pointer or a max pointer in the block, the amount of memory used by the VSB can be reduced. Returning to the above scenario (specified in Step 600), the processor replaces the first pointer in the second block with a zero pointer (0). The method may end after Step 612.

In one or more embodiments, the method described above in FIGS. 5 and 6 may be performed, in part, by using an AND operation, an OR operation, an XOR operation, a NOT operation, or any other suitable bitwise operation. When performing a bitwise operation, the processor may use a DFS algorithm to traverse corresponding VSBs and perform the bitwise operation. The bitwise operation may lead to block sets being allocated and deallocated. The AND operation, the OR operation, the XOR operation, the NOT operation, or any other suitable bitwise operation may be used for other methods not discussed above in reference to FIGS. 5 and 6, which may lead to block sets being allocated or deallocated.

### Start of Example

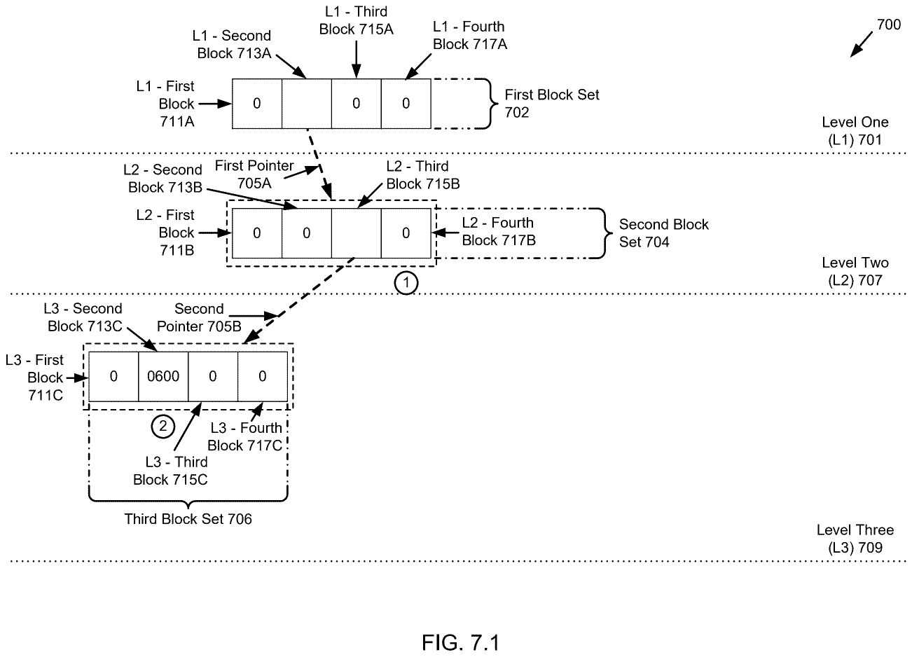

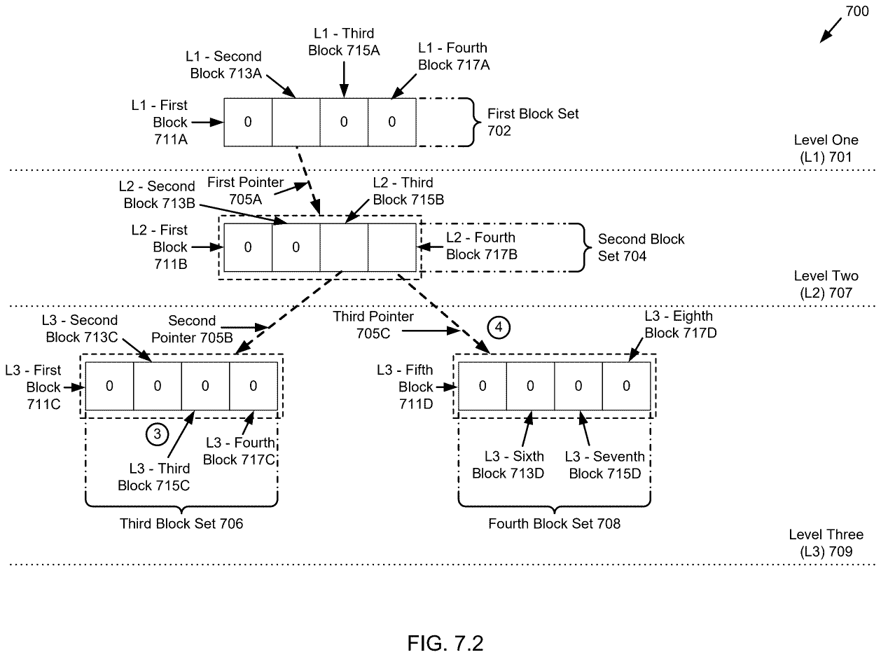

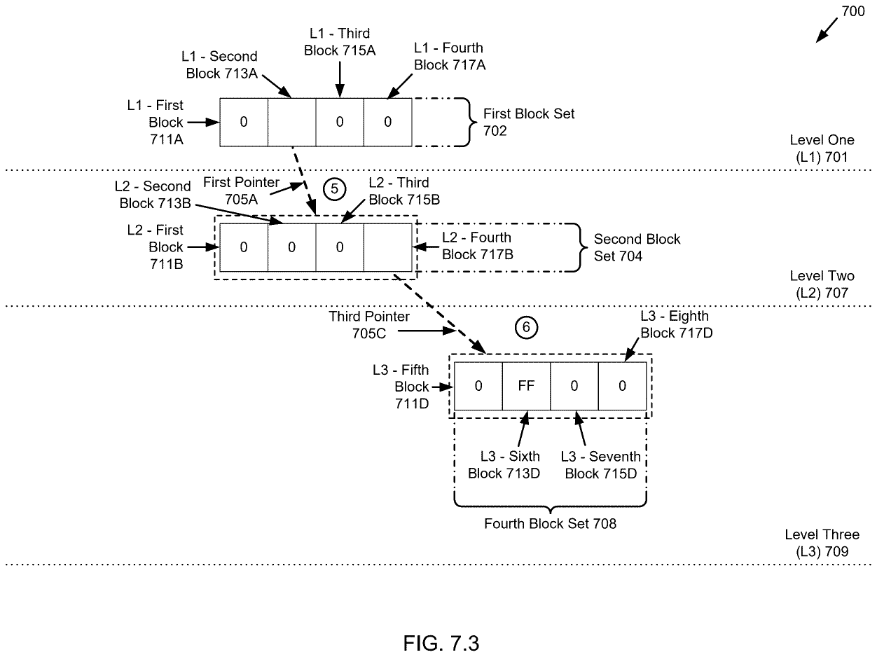

The following section describes an example. The example, illustrated in FIGS. 7.1-7.3, is not intended to limit the disclosure and is independent from any other examples discussed in this application. This example includes only the components necessary to describe the example and other components may be used with the example. Turning to the example, consider a scenario of a VSB (700) as shown in FIG. 7.1. The VSB (700) is shown as having three levels: Level One (L1) (701), Level Two (L2) (707), and Level Three (L3) (709).

Referring to FIG. 7.1, L1 (701) includes the first block set (702), in which the first block set (702) hosts L1—First Block (711A), L1—Second Block (713A), L1—Third Block (715A), and L1—Fourth Block (717A). Further, L1—First Block (711A) includes a zero pointer, indicating that all bits included in L1—First Block (711A) are set/reset to zero. L1—Second Block (713A) includes a first pointer (705A) (e.g., a real pointer) connecting L1—Second Block (713A) to a second block set (704). In addition, L1—Third Block (715A) and L1—Fourth Block (717A) also include zero pointers, indicating that all bits included in each block are set/reset to zero.

Continuing with the discussion of FIG. 7.1, L2 (707) includes the second block set (704) that is referenced by L1—Second Block (713A) of L1 (701). The second block set (704) hosts L2—First Block (711B), L2—Second Block (713B), L2—Third Block (715B), and L2—Fourth Block (717B). With respect to the second block set (704), (i) each of L2—First Block (711B) and L2—Second Block (313B) includes a zero pointer, (ii) L2—Third Block (715B) includes a second “real” pointer (705B) connecting L2—Third Block (715B) to a third block set (706), and (iii) L2—Fourth Block (717B) also includes a zero pointer.

L3 (709) includes the third block set (706) that is referenced by L2—Third Block (715B) of L2 (707). As indicated, L3 (709) is the base level in the VSB (700). Further, (i) L3—First Block (711C) includes a zero pointer, (ii) L3—Second Block (713C) includes “0600”, and (iii) each of L3—Third Block (715C) and L3—Fourth Block (717C) also includes a zero pointer.

Referring to FIG. 7.1, in the example the processor receives instructions for a task to reset two bits in VSB (700) and to set 16 bits in the VSB (700). The processor first identifies the location of the bits to be changed. The processor determines using a DFS algorithm that all 18 bits are connected to L1—Second Block (713A). In response to the determination, the processor traverses from L1—Second Block (713A) to the second block set using the first pointer (705A). In the second block set (704), the processor determines using the DFS model that the two bits to be reset are connected to L2—Third Block (715B). The processer also determines that the 16 blocks to be set are connected to L2—Fourth Block (717B) [1].

In response to the determination on the two bits to be reset, the processor traverses from L2—Third Block (715B) to the third block set (706) using a second pointer (705B). In the third block set (706), the processor determines that the two bits to be reset are located in L3—Second Block (713C) [2].

Turning now to FIG. 7.2, having identified the location of the two bits to be reset, the processor changes the two bits from one to zero. L3—Second Block (713C) goes from having two bits set to one to having all bits reset to zero [3].

Returning to L2—Fourth Block (717B), the processor determines that L2—Fourth Block (717B) is completely reset (i.e., all bits connected to the block are reset to zero) because L2—Fourth Block (717B) includes a zero pointer. The processor then allocates a fourth block set (708) connected to L2—Fourth Block (717B) by a third pointer (705). As indicated, the fourth block set (708) hosts L3—Fifth Block (711D), L3—Sixth Block (713D), L3—Seventh Block (715D), and L3—Eight Block (717D)). All bits in the fourth block set (708) are reset to zero because of L2—Fourth Block (717B) is being completely reset. For the same reason, all blocks in the fourth block set (708) include zero pointers [4].

Turning now to FIG. 7.3, the processor deallocates the third block set (706) because all blocks in the third block set (706) are reset to zero. After deallocating the third block set (706), the second pointer (705B) connecting L2—Third Block (715B) to the third block set (706) is replaced by a zero pointer to indicate that L2—Third Block (715B) is completely reset [5].

Returning to the fourth block set (708), the processor determines that the 16 bits in L3—Sixth Block (713D) are set to be one. The processor changes all the bits in L3—Sixth Block (713D) from zero to one. Because all the bits in L3—Sixth Block (713D) are one, the block is completely set. The processor then places a max pointer (FF) in L3—Sixth Block (713D) [6]. The processor completes the task to reset two bits in VSB (700) and to set 16 bits in the VSB (700). The task leads to the third block set (706) to be deallocated and the fourth block set (708) to be allocated.

### End of Example

Turning now to FIG. 8, FIG. 8 shows an example table of the storage capacity of a VSB in accordance with one or more embodiments disclosed herein. The table lists specifications of a 64-bit pointer tree and a 16-bit offset tree. Starting with the 64-bit pointer tree, as the table shows, a VSB using a 64-bit pointer tree may contain up to 64 mebibits with three levels. A mebibit is defined as 1,048,576 bits. As shown in the table, a VSB using a 64-bit pointer tree may contain up to 2 mebibits with two levels. The pointers have a size of 8 bytes (64 bits). The blocks may have a size of 256 bytes. When the blocks have a size of 256 bytes, each block can contain up to 32 pointers due to the size of both the pointers and the blocks.

In one or more embodiments, a size of a blocks can be tuned. However, the size of the block may be limited by a corresponding “allowed” write size and a related data atomicity unit of a computing device (e.g., 900, FIG. 9) where the VSB is located. The pointer size and the number of levels of the VSB can also be tuned.

In one or more embodiments, tunability of (i) a size of a block (ii) a size of a pointer, and (iii) a number of levels of a VSB may allow for variations in other properties (e.g., a number of blocks in a VSB, a number of bits in the VSB, etc.) of the VSB.

In one or more embodiments, the number of blocks in a given level of the VSB (Y) may be calculated by the following equation:

$$Y = P X$$

where X is the number of blocks in a previous level and P is the number of pointers in a related block. If a VSB has a root level with one block, the VSB would have L1 with 32 blocks, L2 with 1024 blocks, L3 with 1,048,576 blocks, etc.

In one or more embodiments, the size of the VSB (in terms of bits) in a level (Z) can be calculated using the following equation:

$$Z = BY$$

where Y is the number of blocks in the corresponding level and B is the number of bits in the blocks. A block (with a size of 256 bytes) can store 2048 bits. Therefore, a root level may contain 2048 bits in a VSB, L1 may contain up to 65,536 bits in the VSB, L2 may contain up to 2,097,152 bits in the VSB, and L3 may contain up to 67,108,864 bits in the VSB. The number of levels used by the VSB may increase a number of bits the VSB can include.

As discussed above, the block size is tunable. For example, the block size can be 32 bytes. Keeping the pointer size at eight bytes, the number of pointers in a corresponding block is 4 and the number of bits in a block is 256. Using these numbers, the number of blocks is one in the root level, 4 in L1, 16 in L2, and 64 in L3. Therefore, the maximum number of bits is 256 in the root level, 1024 in L1, 4,096 in L2, and 16,384 in L3.

In one or more embodiments, for example, using a block size of 256 bytes, a bit-array that is not a VSB may contain two levels that include up to 2,097,152 bits. If only 50 of those bits are set and the rest of the bits are reset, the memory footprint is high relative to the number of bits set (e.g., 2,097,152 bits compared to 50 bits). Instead, if a VSB is used, and all 50 of those bits in L2 are contained by a single parent block in L1 (i.e., all 50 bits are in a single level two block set), the other blocks in L1 can include with zero pointers, which would deallocate all but the one block set on L2 (i.e., 32 blocks). The memory footprint would be low relative to the number of bits set as 992 blocks in the VSB can be deallocated to free up 2,031,616 bits of memory (that would be used without a VSB).

Turning to the 16-bit offset tree (in FIG. 8), a VSB using a 16-bit offset tree may contain up to 128 mebibits with three levels. Using a VSB with two levels, a 16-bit offset tree may contain up to 32 mebibits. The offset pointers may have a size of 2 bytes (16 bits). The blocks may have a size of 256 bytes. Each block can contain up to 128 offset pointers because of the size of both the pointers and the blocks.

In one or more embodiments, the size of the offset pointers is tunable. The size may be 24 bits, 32 bits, or another. The block size and the number of levels are also tunable similar to the 64-bit pointer tree.

In one or more embodiments, the equations discussed above (with respect to the 64-bit pointer tree) may also apply to the 16-bit offset tree. If a root level has one block, L1 may have 128 blocks, L2 may have 16,384 blocks, but L3 may be limited to 65,536 blocks (because of the constraints associated with offset trees based on the size of the offset). To this end, the root level can contain 2048 bits in a VSB, L1 can contain 262,144 bits in a VSB, L2 can contain 33,554,432 bits in a VSB, and L3 can contain 134,217,728 bits in a VSB.

As discussed above, embodiments of the disclosure may be implemented using computing devices. FIG. 9 shows a diagram of a computing device (900) in accordance with one or more embodiments of the disclosure. The computing device (900) may include one or more computer processor(s) (902), non-persistent storage (904) (e.g., volatile memory, such as RAM, cache memory), persistent storage (906) (e.g., a hard disk, an optical drive such as a compact disk (CD) drive or digital versatile disk (DVD) drive, a flash memory, etc.), a communication interface (912) (e.g., Bluetooth interface, infrared interface, network interface, optical interface, etc.), input devices (910), output devices (908), and numerous other elements (not shown) and functionalities. Each of these components is described below.

In one embodiment of the disclosure, the processor(s) (902) may be an integrated circuit for processing instructions. For example, the computer processor(s) may be one or more cores or micro-cores of a processor. The computing device may also include one or more input devices (910), such as a touchscreen, keyboard, mouse, microphone, touchpad, electronic pen, or any other type of input device. Further, the communication interface (912) may include an integrated circuit for connecting the computing device to a network (not shown) (e.g., a local area network (LAN), a wide area network (WAN) such as the Internet, mobile network, or any other type of network) and/or to another device, such as another computing device.

In one embodiment of the disclosure, the computing device (900) may include one or more output devices (908), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (902), non-persistent storage (904), and persistent storage (906). Many different types of computing devices exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to enable the computer processor to perform one or more embodiments described herein.

The problems discussed above should be understood as being examples of problems solved by embodiments of the disclosure disclosed herein and the disclosure should not be limited only to solving the same/similar problems. The disclosure is broadly applicable to address a range of problems beyond those discussed herein.

Specific embodiments are described with reference to the accompanying figures. In the above description, numerous details are set forth as examples. It will be understood by those skilled in the art, that one or more embodiments of the present disclosure may be practiced without these specific details, and that numerous variations or modifications may be possible without departing from the scope. Certain details known to those of ordinary skill in the art are omitted to avoid obscuring the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A method of adjusting bits in a virtual sparse bit-array (VSB), comprising:
identifying a first block on a level one of the VSB comprising a first bit to be reset;
making a first determination that the first block is completely set, wherein, when each of second bits in the first block are set to one, the first block is completely set;
based on the first determination, allocating a first block set on a level two of the VSB connected to the first block on the level one by a first pointer, wherein the first pointer shows that the first block comprises the first block set;
after allocating the first block set:
switching to a second block of the first block set on the level two using the first pointer;
making a second determination that the first bit is stored in the second block, wherein third bits in the second block are set to one; and
resetting, based on the second determination, the first bit to zero.

2. The method of claim 1, further comprising:
identifying a third block on the level one of the VSB containing a fourth bit to be set;
making a third determination that the third block is completely reset, wherein, when each of fifth bits in the third block are set to zero, the third block is completely reset;
based on the third determination, allocating a second block set on the level two of the VSB connected to the third block by a second pointer, wherein the second pointer shows that the second block comprises the second block set;
after allocating the second block set:
switching to a fourth block of the second block set on the level two using the second pointer;
making a fourth determination that the fourth bit is stored in the fourth block of the second block set on the level two, wherein sixth bits in the fourth block are reset to zero; and
setting, based on the fourth determination, the fourth bit to one.

3. The method of claim 1, wherein an AND operation, an OR operation, or an exclusive OR (XOR) operation is used to adjust the first bit in the VSB.

4. The method of claim 1, wherein the first pointer has a size of eight bits and the second block has eight bits.

5. The method of claim 4, wherein the VSB has a size of 128 bits with a plurality of bits pre-set.

6. The method of claim 1, further comprising:
transitioning the VSB from a pointer tree to an offset tree using a memory translation table by replacing the first pointer with a first offset pointer.

7. The method of claim 6, wherein the VSB as an offset tree is persistent and exists on a system through a system shutdown.

8. A method of adjusting bits in a virtual sparse bit-array (VSB), comprising:
identifying a first block on a level one of the VSB comprising a first bit to be reset;
making a first determination that the first block has a first pointer connected to a second block on a first block set on a level two of the VSB, wherein the first pointer shows that the first block comprises the first block set;
based on the first determination, switching to the second block of the first block set, wherein one bit of second bits is set to one and all other second bits are reset to zero;
making a second determination that the first bit is the one bit of the second bits set to one;
based on the second determination:
resetting the first bit to zero;
making a third determination, in response to resetting the first bit, that all second bits in the first block set are set to zero; and
deallocating, in response to the third determination, the first block set, wherein deallocating the first block set comprises:
removing the first block set, and
replacing the first pointer in the first block with zero to indicate second bits in the first block are reset to zero.

9. The method of claim 8, further comprising:
identifying a third block on the level one of the VSB containing a third bit to be set;
making a fourth determination that the third block has a second pointer connected to a fourth block on a second block set on the level two of the VSB, wherein the second pointer shows that the third block comprises the second block set;
based on the fourth determination, switching to the fourth block of the second block set, wherein one bit of fourth bits is set to zero and all other fourth bits are set to one;
making a fifth determination that the third bit is the one bit of the fourth bits set to zero;
based on the fifth determination:
setting the third bit to one;
making a sixth determination, in response to setting the third bit, that all the fourth bits in all blocks in the second block set are set to one; and
deallocating, in response to the sixth determination, the second block set, wherein deallocating the second block set comprises:
removing the second block set, and
replacing the second pointer in the third block with FF to indicate all the fourth bits in the first block are set to one.

10. The method of claim 8, wherein an AND operation, an OR operation, or an exclusive OR (XOR) operation is used to adjust the first bit in the VSB.

11. The method of claim 8, wherein the first pointer has a size of eight bits and the second block has eight bits.

12. The method of claim 9, wherein the VSB has a size of 128 bits with no bits set.

13. The method of claim 8, further comprising:
transitioning the VSB from a pointer tree to an offset tree using a memory translation table by replacing the first pointer with a first offset pointer.

14. The method of claim 8, wherein the VSB as an offset tree is persistent and exists on a system through a system shutdown.

15. A non-transitory computer readable medium (CRM) comprising computer readable program code, which when executed by a computer processor enables the computer processor to perform a method of adjusting bits in a virtual sparse bit-array (VSB), the method comprising:
identifying a first block on a level one of the VSB comprising a first bit to be reset;
making a first determination that the first block is completely set, wherein, when each of second bits in the first block are set to one, the first block is completely set;
based on the first determination, allocating a first block set on a level two of the VSB connected to the first block on the level one by a first pointer, wherein the first pointer shows that the first block comprises the first block set;
after allocating the first block set:
switching to a second block of the first block set on the level two using the first pointer;
making a second determination that the first bit is stored in the second block, wherein third bits in the second block are set to one; and
resetting, based on the second determination, the first bit to zero.

16. The non-transitory CRM of claim 15, further comprising:
identifying a third block on the level one of the VSB containing a fourth bit to be set;
making a third determination that the third block is completely reset, wherein, when each of fifth bits in the third block are set to zero, the third block is completely reset;
based on the third determination, allocating a second block set on the level two of the VSB connected to the third block by a second pointer, wherein the second pointer shows that the second block comprises the second block set;
after allocating the second block set:
switching to a fourth block of the second block set on the level two using the second pointer;
making a fourth determination that the fourth bit is stored in the fourth block of the second block set on the level two, wherein all sixth bits in the fourth block are reset to zero; and
setting, based on the fourth determination, the fourth bit to one.

17. The non-transitory CRM of claim 15, wherein an AND operation, an OR operation, or an exclusive OR (XOR) operation is used to adjust the first bit in the VSB.

18. The non-transitory CRM of claim 15, wherein the first pointer has a size of eight bits and the second block has eight bits.

19. The non-transitory CRM of claim 18, wherein the VSB has a size of 128 bits with a plurality of bits pre-set.

20. The non-transitory CRM of claim 15, further comprising:
translating the VSB from a pointer tree to an offset tree using a memory translation table by replacing the first pointer with a first offset pointer.
